(19) United States
(12) Patent Application Publication
(10) Pub. No.: US 2018/0064095 A1
(43) Pub. Date: Mar. 8, 2018

(54) Dripper Bag for Attracting Game and Fish

(71) Applicant: Delco, LLC, Broken Arrow, OK (US)

(72) Inventors: Patrick Brendan Delehanty, Broken Arrow, OK (US); Jeremy Wade Crocker, Brighton, CO (US)

(73) Assignee: Delco, LLC, Broken Arrow, OK (US)

(21) Appl. No.: 15/697,296

(22) Filed: Sep. 6, 2017

Related U.S. Application Data
(60) Provisional application No. 62/383,631, filed on Sep. 6, 2016.

(51) Int. Cl. A01M 31/00

(52) U.S. Cl. CPC A01M 31/008; A01K 97/04

(57) ABSTRACT

Embodiments of the Dripper Bag for Attracting Game and Fish are comprised of a pouch, where the pouch forms a sombrero hang hole, a duel core tin tie removably affixed to the side of the pouch, a spout, a foil tamper seal, and a spout cap, and where on the bottom of the dripper bag is formed three selections of areas to puncture with varying flow rate and therefore varying total effluent time.

### STATEMENT REGARDING FEDERALLY SPONSORED RESEARCH OR DEVELOPMENT

Not applicable

### BACKGROUND OF THE EMBODIMENTS

### Field of the Embodiments

The general field of the embodiments of the Dripper Bag for Attracting Game and Fish is game hunting and fishing accessories. More specifically, the field of the embodiments relates to dispersal of attractant fluids for attracting game animals and fish.

### Description of Prior Art

Hunting game routinely requires the hunter to place scent in the field to attract game. The prior art consists of containers of scent placed in a location and opened to allow the scent to escape. A drawback of the prior art is that these devices are expensive and do not provide a long-duration of scent application.

### SUMMARY OF THE EMBODIMENTS

Embodiments of the Dripper Bag for Attracting Game and Fish are comprised of a pouch, where the pouch forms a sombrero hang hole, a duel core tin tie removably affixed to the side of the pouch, a spout, a foil tamper seal 902, and a spout cap, and where on the bottom of the dripper bag is formed three selections of areas to puncture with varying flow rate and therefore varying total effluent time.

There has thus been outlined, rather broadly, the more important features of the embodiments of the Dripper Bag for Attracting Game and Fish in order that the detailed description thereof that follows may be better understood, and in order that the present contribution to the art may be better appreciated. There are, of course, additional features of the embodiments that will be described hereinafter and which will form the subject matter of the claims appended hereto.

In this respect, before explaining at least one embodiment of the embodiments in detail, it is to be understood that the embodiment is not limited in this application to the details of construction and to the arrangements of the components set forth in the following description or illustrated in the drawings. The embodiment or embodiments are capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be used as a basis for the designing of other structures, methods and systems for carrying out the several purposes of the embodiments. Additional benefits and advantages of the embodiments will become apparent in those skilled in the art to which the present embodiments relate from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application which is measured by the claims, nor is it intended to be limiting as to the scope of the embodiments in any way.

### BRIEF DESCRIPTION OF THE DRAWINGS

FIG. 1A is a perspective view of an embodiment of a large Dripper Bag for Attracting Game and Fish; FIG. 1B is a perspective view of an embodiment of a large Dripper Bag for Attracting Game and Fish.

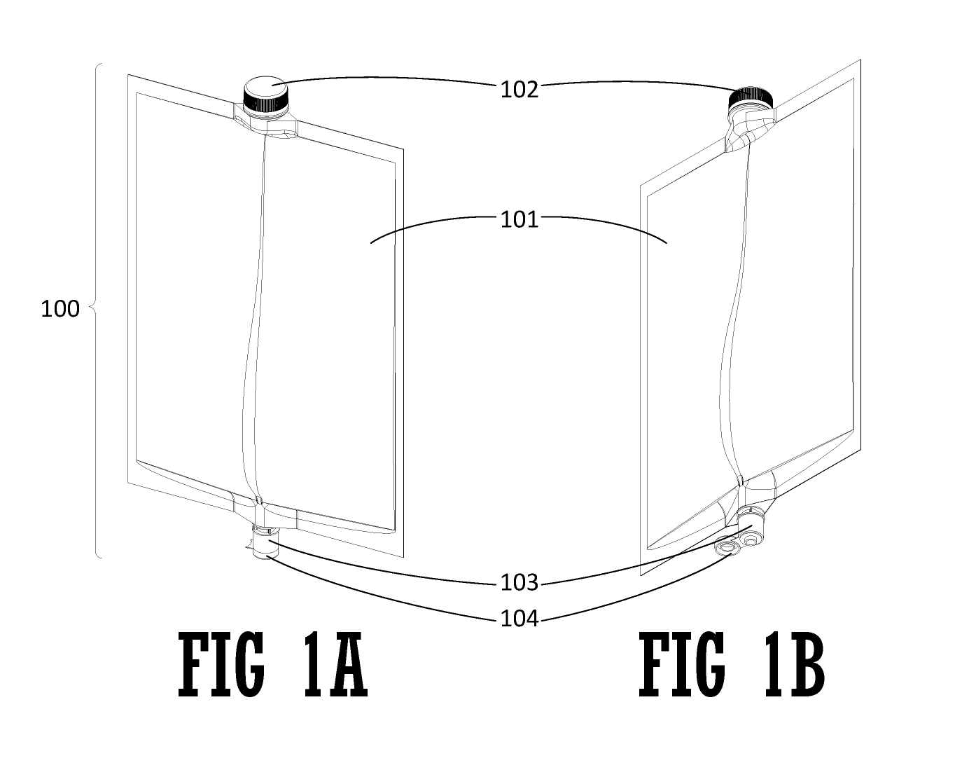

FIG. 2 is a perspective view of an embodiment of a large Dripper Bag for Attracting Game and Fish.

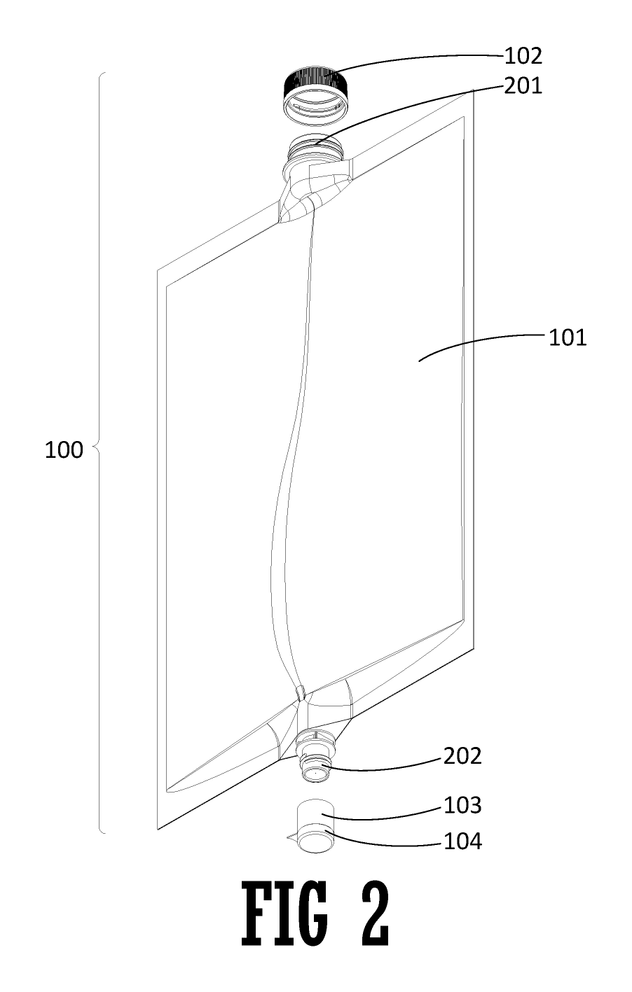

FIG. 3A is a front view of an embodiment of a large Dripper Bag for Attracting Game and Fish; FIG. 3B is a bottom view of an embodiment of a large Dripper Bag for Attracting Game and Fish; FIG. 3C is a side view of an embodiment of a large Dripper Bag for Attracting Game and Fish.

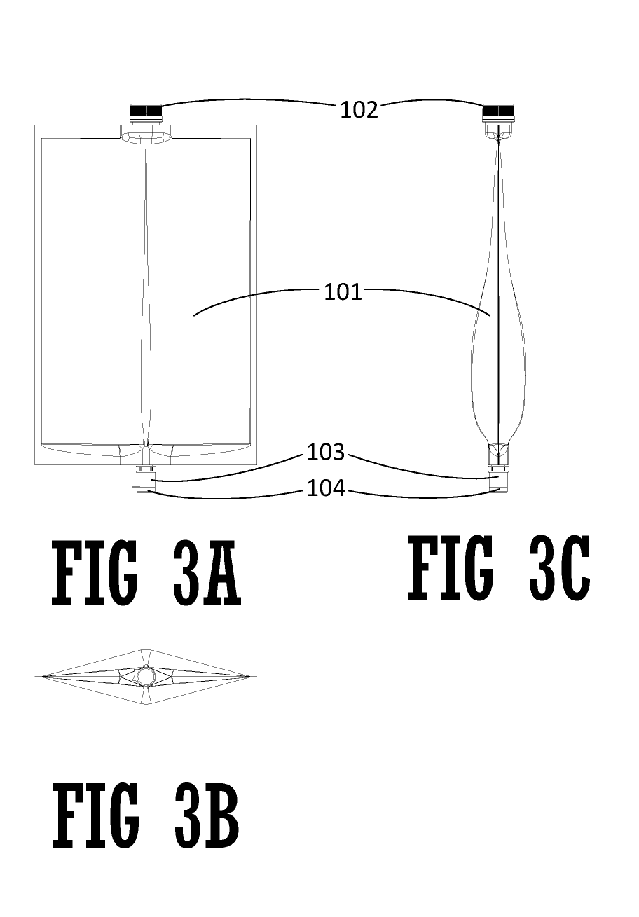

FIG. 4A is a front view of an embodiment of a large Dripper Bag for Attracting Game and Fish with a ball valve dispenser in the closed position; FIG. 4B is a front view of an embodiment of a large Dripper Bag for Attracting Game and Fish with a ball valve dispenser in the open position.

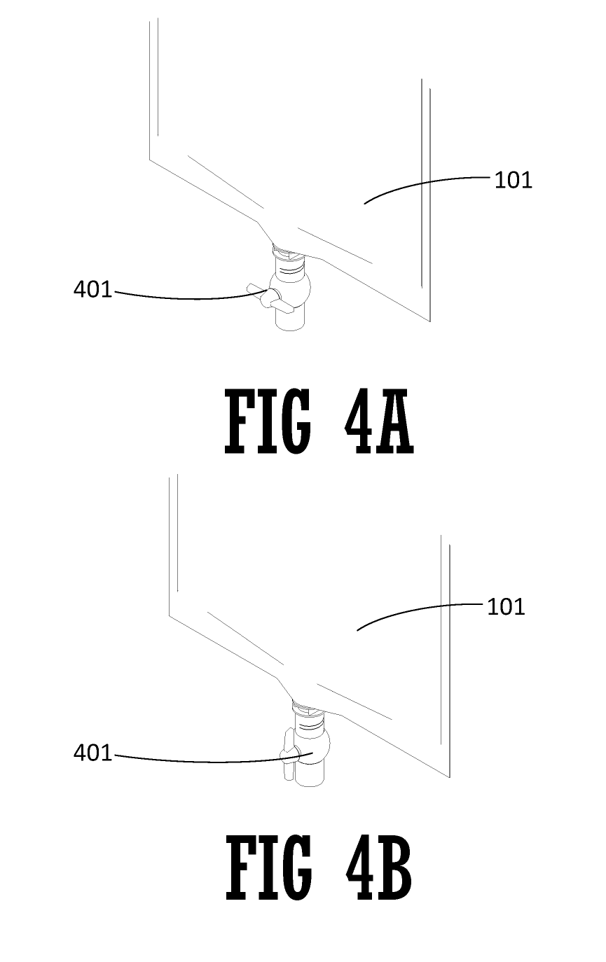

FIG. 5 is a perspective view of an embodiment of a small Dripper Bag for Attracting Game and Fish.

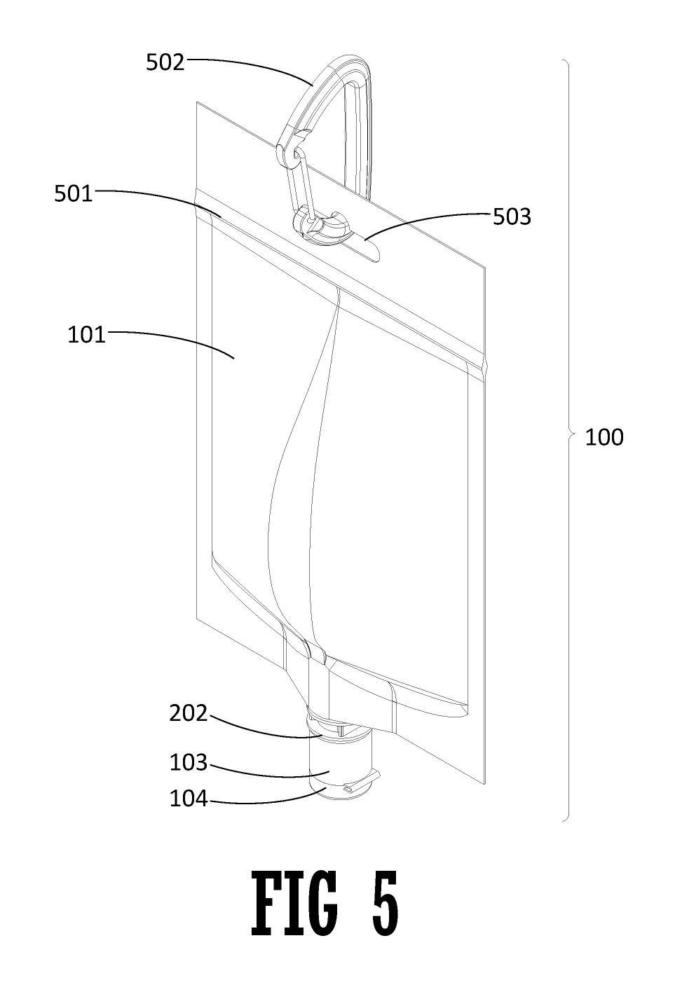

FIG. 6 is a perspective view of an embodiment of a small Dripper Bag for Attracting Game and Fish.

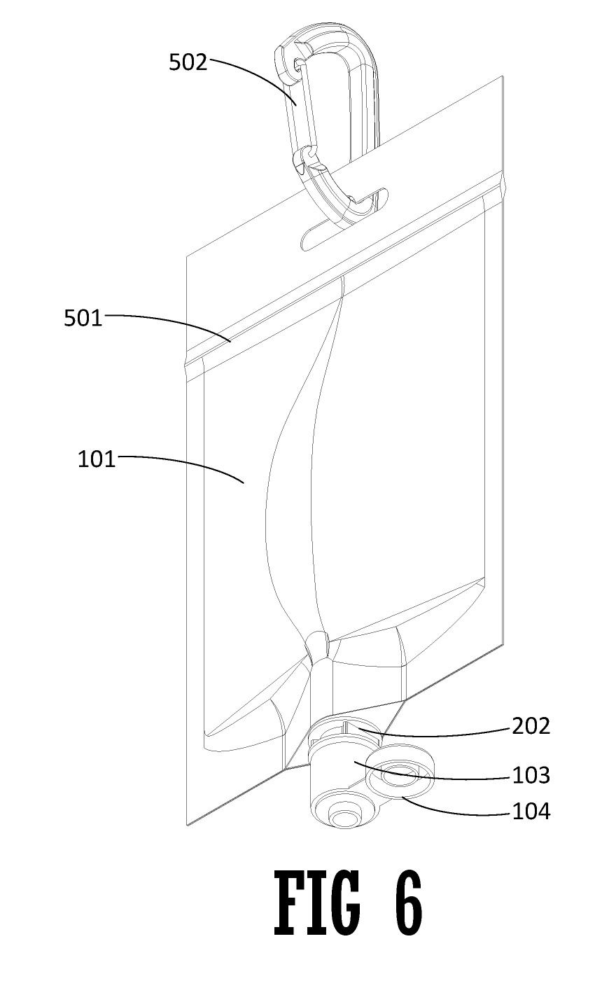

FIG. 7 is a perspective view of an embodiment of a small Dripper Bag for Attracting Game and Fish.

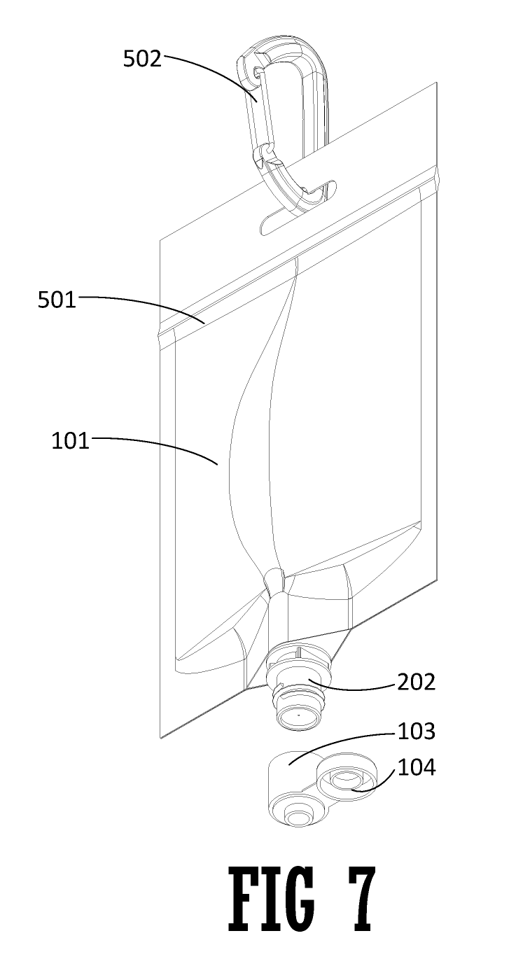

FIG. 8A is a front view of an embodiment of a small Dripper Bag for Attracting Game and Fish; FIG. 8B is a bottom view of an embodiment of a small Dripper Bag for Attracting Game and Fish; FIG. 8C is a side view of an embodiment of a small Dripper Bag for Attracting Game and Fish.

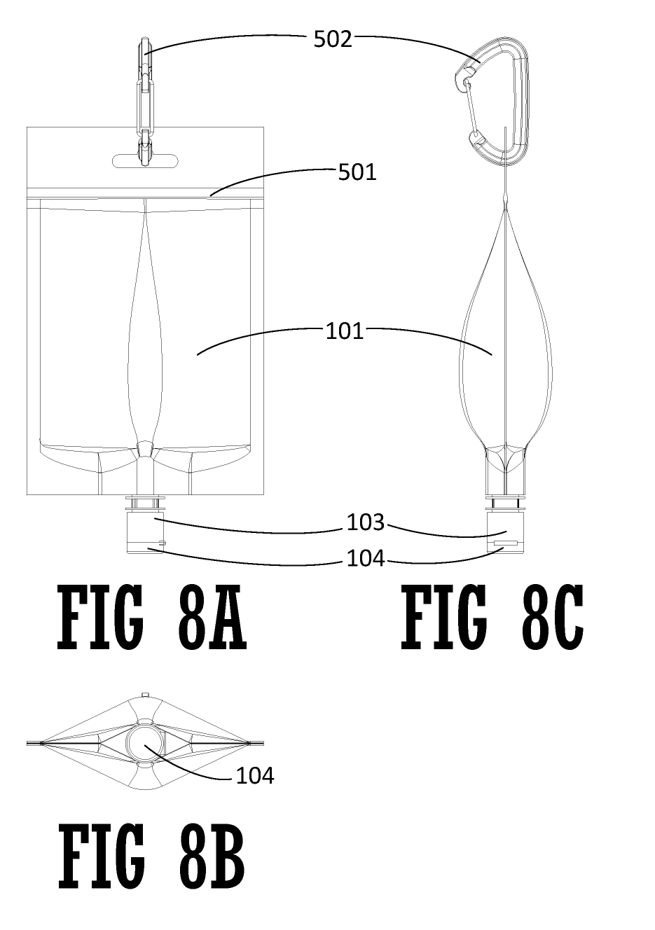

FIG. 9 is a front view of an embodiment of a small Dripper Bag for Attracting Game and Fish with the optional duel core tin tie removably affixed to the side of the pouch.

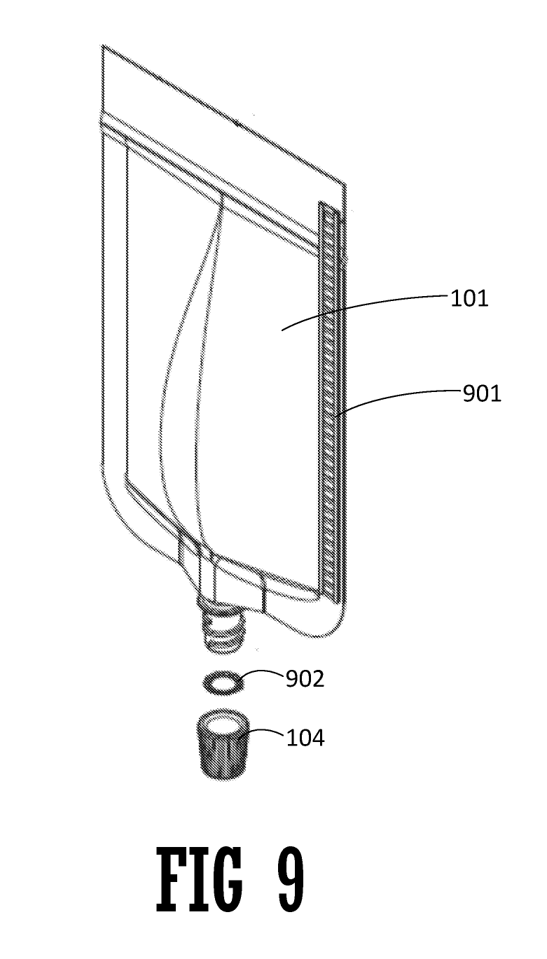

FIG. 10A is a front view of an embodiment of the optional duel core tin tie; FIG. 10B is a front exploded view of an embodiment of the optional duel core tin tie; FIG. 10C is a perspective view of portion of an embodiment of the optional duel core tin tie.

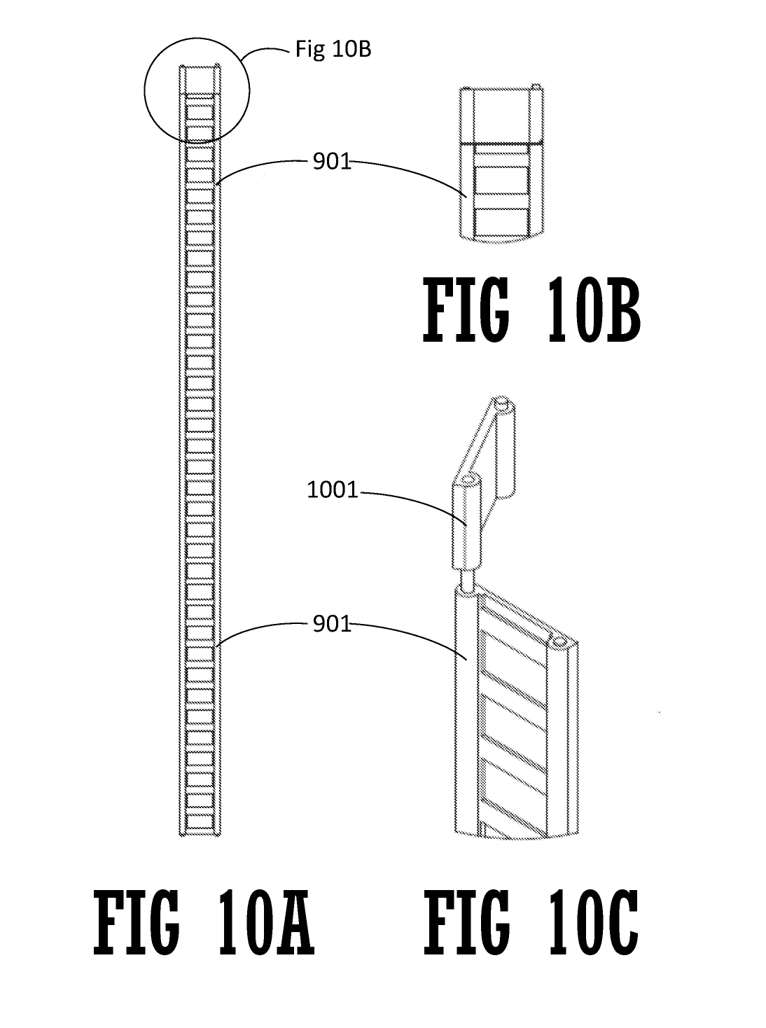

### DETAILED DESCRIPTION OF THE PREFERRED EMBODIMENTS

Embodiments of the Dripper Bag for Attracting Game and Fish 100 comprise a pouch 101, a top cap 102, a spout 103, a spout cap 104, and a spout aperture 202.

Another embodiment of the Dripper Bag 100 comprises a pouch 101, where the pouch forms a sombrero hang hole 503, a duel core tin tie 901 removably affixed to the side of the pouch 101. On the bottom of the dripper bag is formed three selections of areas to puncture with varying flow rate and therefore varying total effluent time. Another embodiment of the Dripper Bag 100 comprises an optional carabiner 502 that is threaded through the sombrero hang hole 503 and is used to attached the Dripper Bag 100 to a tree, fence, or other structure from which to hang the Dripper Bag 100.

Another embodiment of the Dripper Bag 100 comprises an optional zip aperture 501. The zip aperture 501 forms interlocking ridges near the edges of the opening to be easily closed or sealed by pressing one side of the opening against the other. The zip aperture 501 can be used to fill the pouch 101 with liquid attractant.

The pouch 101 is comprised of thin polymeric material or thin metallized polymeric material that is used to contain the liquid scent or liquid attractant desired to be distributed. The pouch is a fixed at its bottom to a spout. In one embodiment, the spout is comprised of a spout aperture 103 and a spout aperture cap 104. In another embodiment, the spout is comprised of a spout ball valve 401. The spout ball valve 401 can be used to adjust the rate of flow of the contents of the Dripper Bag for Attracting Game and Fish 100 per the requirements of the user.

In another embodiment of the Dripper Bag 100 the spout is 10 mm in diameter and the spout is covered with a foil tamper seal 902. The tamper seal 902 provides the means to drip the liquid scent from the pouch. The tamper seal 902 is covered with a spout cap 104 for shipment and transportation and to prevent inadvertent puncture of the foil tamper seal. A dual core tin tie 901 is a fixed to the side of the pouch 101 with an adhesive means that permits removal of the dual core tin tie 901. The pouch 101 also forms an opening in the form of a sombrero 503 at the top of the pouch to permit hanging of the pouch 101 from a tree or other vertical structure.

The dual core tin tie has added at its end a pre-serrated separation cut approximately 0.25 inches from its tip. This pre-serrated separation cut permits the user to grasp the plastic sheath 1001 end of the dual core tin tie 901 and remove the plastic sheath 1001 from the end. The dual core tin tie 901 can then be used to puncture the foil tamper seal 902 on the spout permitting flow of the liquid scent.

The spout 103 is comprised of a threaded connection that permits removal of the spout cap 104. On the end of the spout 103 is placed with adhesive means the foil tamper seal 902. The spout cap 104 is then threadedly affixed to the spout.

In another embodiment of the Dripper Bag 100 the spout 103 comprises a dripper nozzle and a cap. In this embodiment, the flow is regulated by the size of the dripper nozzle. Dripper nozzles of various si In yet another embodiment of the of the Dripper Bag 100 a spout insert is placed between the pouch and the nozzle. The spout insert allows the user to regulate the flow of the liquid scent by replacing the spout insert with appropriately flow rated inserts.

What we claimed is:

1) A dripper bag for attracting game and fish comprising a pouch, where the pouch forms a sombrero hang hole, a duel core tin tie removably affixed to the side of the pouch, a spout, a foil tamper seal, and a spout cap, and where on the bottom of the dripper bag is formed three selections of areas to puncture with varying flow rate and therefore varying total effluent time.
